(19) United States
(12) Patent Application Publication
(10) Pub. No.: US 2003/0115320 A1
(43) Pub. Date: Jun. 19, 2003

(54) Method for tuning voice playback ratio to optimize call quality

(76) Inventors: Lamonte H.P. Yarroll, Palatine, IL (US); Edward Chen, Palatine, IL (US)

Correspondence Address: MOTOROLA, INC., 1303 EAST ALGONQUIN ROAD, IL01/3RD, SCHAUMBURG, IL, 60196

(21) Appl. No.: 10/024,797

(22) Filed: Dec. 19, 2001

(51) Int. Cl. G06F 15/173; H04Q 7/20

(52) U.S. Cl. 709/224; 455/423

(57) ABSTRACT

An apparatus and method for tuning voice playback ratio (pbr) to optimize call quality in a packet voice communications system, while taking into account network conditions. The pbr is the ratio of resampling rate to the original sampling rate. The invention also optimizes jitter buffer length (jb₀) for call quality. Between bursts of speech, the preferred embodiment of the invention optimizes call quality by varying the initial jb₀ and the pbr to achieve the best R-factor (R). R is an estimate of customer satisfaction with the quality of a voice call in real time. During bursts of speech, the value of jb₀ is fixed at the beginning of the BOS and the pbr is varied to achieve the best R. The method can be implemented during a burst of speech and between bursts of speech whenever the network conditions change.

### FIELD OF THE INVENTION

The present invention relates generally to the field of communication systems, and more particularly, to a method for tuning voice playback ratio to optimize call quality.

### BACKGROUND OF THE INVENTION

In a communications system, jitter is a term used to describe variation in interpacket arrival times. A jitter buffer is a digital storage device used to compensate for a difference in the rate of flow of information or the time of occurrence of events when transmitting information from one device to another. The jitter buffer approximates a first-in-first-out (FIFO) with a variable input rate and a constant output rate. In a typical communication system, a jitter buffer typically operates as follows. When a first packet arrives at the receiver's side, the packet is placed in the jitter buffer. The receiver then starts a timer. For voice, the timer value is typically a fixed number on the order of 100 ms to 200 ms. The timer value is called the length of the jitter buffer. When the timer expires, the receiver reads the packet from the buffer and uses it. The receiver then sets a recurring timer. The interval of the recurring timer matches the nominal duration of each voice packet. As the following packets arrive, the receiver places them in the jitter buffer. As the timer expires, the reader reads the next packet from the buffer. If a packet has not arrived by the time the receiver attempts to read it from the buffer, the packet is counted as lost.

Internet Protocol (IP) networks are designed to carry primarily real-time data. As such, voice data may experience significant delay, jitter and loss when crossing IP networks. Most current technologies use dynamic jitter buffer algorithms to compensate for the difference in the rate of network flow regardless of the current network conditions. U.S. Pat. No. 5,790,538 ('538 patent) issued to Gary Sugar on Aug. 4, 1998, describes a method of tuning jitter buffer size. However, the method of the '538 patent does not account for cognitive effects such as listener perception and the effects of loss on the coder-decoder (CODEC).

Thus, there is a need for an apparatus and method for adjusting the jitter buffer size according to network conditions that addresses the drawbacks of the prior art.

### BRIEF DESCRIPTION OF THE DRAWINGS

FIG. 1 is a block diagram of the preferred embodiment of the apparatus of the present invention.

FIG. 2 is a graph of the conversion between R-factor and Mean Opinion Score (MOS) that can be used to estimate impairment factors for CODECs not included in ETR-250.

FIG. 3 is a graph of impairment factor I_{dd} for various values of E-E Delay.

FIG. 4 is a graph of impairment factor Ieₗₒₛₛ for various values of average jbₗₒₛₛ.

FIG. 5 is a graph of playback time for various values of jitter buffer length.

FIG. 6 is a graph of jitter buffer overflow for various values of pbt and average delay.

FIG. 7 is a graph of impairment factor I_{pbr} for various values of pbr.

FIG. 8 is a table of R-factors for various combinations of jb₀ and pbr.

FIG. 9 is a flow chart of the preferred embodiment of the method of the present invention.

FIG. 10 is a flow chart of the preferred embodiment of step 904 in the flow chart of FIG. 9.

FIG. 11 is a flow chart of the preferred embodiment of step 1008 in the flow chart of FIG. 10.

### DETAILED DESCRIPTION OF THE DRAWINGS

The present invention provides an apparatus and method for tuning voice playback ratio to optimize call quality in a packet voice communications system, while taking into account network conditions. In particular, the invention optimizes jitter buffer length for call quality. Between bursts of speech, the invention controls jitter buffer length by varying the initial jitter buffer length (jb₀) and the playback ratio (pbr). During bursts of speech, jb₀ is measured and the pbr is varied. The pbr is the ratio of resampling rate to the original sampling rate. The invention is useful in networks having moderate to high jitter. Such networks typically have high packet loss ratios (fraction of packets lost from a stream by a network due to errors or congestion) and high end-to-end delays (amount of time between a speaker producing a sound and a listener hearing the sound). In the preferred embodiment, the invention causes speech that is stored in the buffer to be played back slower than normal. This allows the system to start with a short jitter buffer and grow the jitter buffer as needed to improve voice quality. A shorter initial jitter buffer reduces end-to-end delay.

Referring to FIG. 1, the preferred embodiment of the apparatus 100 of the present invention is shown. In the present invention, the voice decoder 104 controls the rate at which bits (voice data) are removed from the jitter buffer 102. This allows the jitter buffer 102 to vary dynamically between bursts of speech (InterBOS) and during bursts of speech (IntraBOS). The voice decoder 104 is coupled to a voice resampler 106. The voice resampler 106 controls the number of Pulse Code Modulation (PCM) bits per second coming out of the voice decoder 104, and consequently, the rate at which the voice decoder 104 removes bits from the jitter buffer 102. The voice resampler 106 accomplishes this by resampling the bit stream from the voice decoder 104 to higher or lower bit rates. This has the effect of speeding up or slowing down the speech that the listener eventually hears. The jitter buffer 102, voice decoder 104 and voice resampler 106 are implemented in software and are commonly known in the art.

The preferred embodiment of the present invention utilizes a new element, a playback optimizer 108, which is coupled to the jitter buffer 102 and voice resampler 106. IntraBOS, the playback optimizer 108 gathers statistics on the status of the communication link (e.g. transmission delay, packet loss, jitter buffer effects, etc.), estimates the resulting call quality and updates the voice resampler to move the call quality closer to optimum. InterBOS, the playback optimizer 108 resets the length of the jitter buffer 102 and the initial playback ratio of the voice resampler 106. The playback optimizer 108 selects the new values based on simulations of the previous BOS with alternative initial jb₀ and pbrs. The playback optimizer 108 is implemented in software on any computer or processor commonly known in the art.

In order to take listener perception into account, the invention uses Section 9.2 of Transmission and Multiplexing™; Speech Communication Quality From Mouth to Ear for 3.1 kHz Handset Telephony Across Networks (ETR-250), Sophia Antipolis, Valbonne France, 1996. ETR-250 describes a method of mapping network characteristics to customer satisfaction ratings called the “e-model.” The ETR-250 e-model is used in the method of the present invention to estimate customer satisfaction with the quality of a voice call in real time. The e-model seeks to convert each impairment in a telephone call into a score on a psychological scale. The effects on the psychological scale are additive. Units on the psychological scale are called Impairment Factors (IFs) and an overall score on the scale is an R-factor (R). The apparatus and method of the present invention develops a revised form of the e-model equation:

R=R₀−Ie_{c}−Ieₗₒₛₛ−Ie_{pbr}−Ie_{DD}. (1)

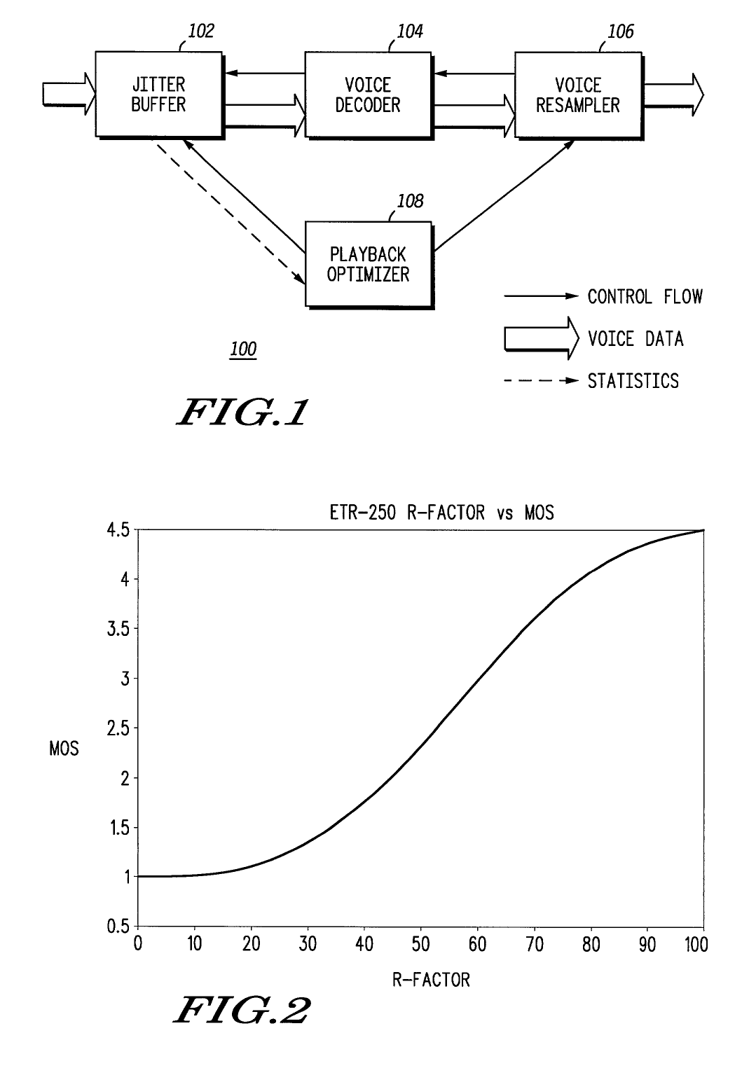

(Equation (1) includes only those quantities that are pertinent to the present invention.) R₀ represents in principle the basic signal-to-noise ratio (SNR) of the voice transmission at the 0 dBr point nearest side. Ie_{c} represents the impairment due to encoding with a specific CODEC. ETR-250 provides a table with values for various CODECs. One may also use the Mean Opinion Score (MOS) conversion in the graph of FIG. 2 to estimate IFs for CODECs not included in ETR-250. As known in the art, the MOS is an estimation of customer satisfaction on a scale of 1 (worst) to 5 (best). Ie_{DD} is the impairment due to a high absolute end-to-end delay (delay on the link plus any delay due to jitter). The present invention introduces new elements Ieₗₒₛₛ and Ie_{pbr} into the ETR-250 e-model equation. Ieₗₒₛₛ describes the behavior of a specific CODEC under conditions of frame loss. The present invention works best with CODECs that have a high tolerance for frame loss. However, the invention also works with loss-sensitive CODECs. Ie_{pbr} is the impairment due to variations in speech reproduction rate. The apparatus and method of the present invention has the ability to playback speech at a slower than normal rate.

In order to improve call quality by adjusting the jitter buffer size according to networks conditions, the present invention is concerned with three network elements that affect packet voice networks—delay, jitter and loss. The graph of FIG. 3 shows the relationship between end-to-end delay and IF. FIG. 3 can be obtained from FIG. 52 (Impairment Factor I_{DD} as a function of the absolute one-way transmission time) of ETR-250 and formulas 9.1.34, 9.1.35 and 9.1.36, which are herein incorporated by reference. As shown in FIG. 3, very small delays, those less than 150 ms, have no measurable effect on the listener's perception of call quality. As delay increases, the effect becomes steadily more noticeable. Once delays become large, small changes no longer have much effect. The preferred embodiment of the apparatus and method of the present invention uses FIG. 3 to obtain the IF I_{DD} for a given value of end-to-end delay.

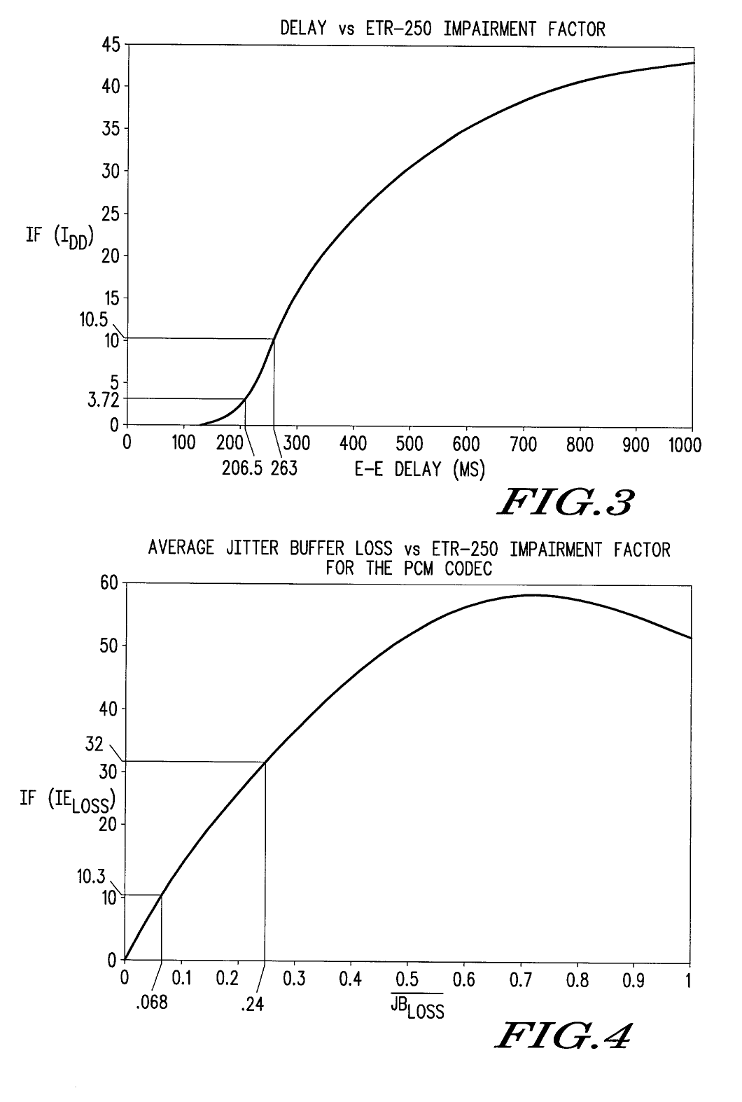

The effects of the second network element, loss, are specific to the particular CODEC used in the network. In the preferred embodiment of the present invention, a PCM CODEC is used. In accordance with ETR-250, the graph of FIG. 4 is an approximation of the effects of loss on IF Ieₗₒₛₛ for a PCM CODEC. The graph can be determined by running MOS experiments as described in Section 2.5 (Opinion Tests) of the Handbook on Telephonometry, ITU-T (CCITT), Geneva 1992, which is incorporated herein by reference. The graph is also based on Perceptual Speech Quality Measure (PSQM) scores which are described in P.861 Objective Quality Measurement of Telephone-band (300-3400 Hz) speech codecs (February 1998), which is incorporated herein by reference. As shown in FIG. 4, a PCM CODEC degrades fairly linearly until around 40%.

The third network element, jitter, describes the variations in intervals between packets. A jitter buffer, such as jitter buffer 102 in FIG. 1, removes jitter by converting it into either of the two previously described network elements—delay or loss. Details of the conversion will now be discussed. A jitter buffer converts jitter into delay by holding onto packets for a predictable amount of time. The graph of FIG. 5 illustrates this concept. The graph shows the amount of delay induced by jitter buffers of different lengths. For illustrative purposes, the average transmission delay (amount of time for transmission between a sender and a receiver) is 200 ms. In this case, the jitter buffer adds 200 ms to each packet so that all packets experience the same end-to-end delay. For example, 200 ms is added to packets in a jitter buffer of length 200 ms to produce a playback time (pbt) of 400 ms; 200 ms is added to packets in a jitter buffer of length 400 ms to produce a pbt of 600 ms; and so on.

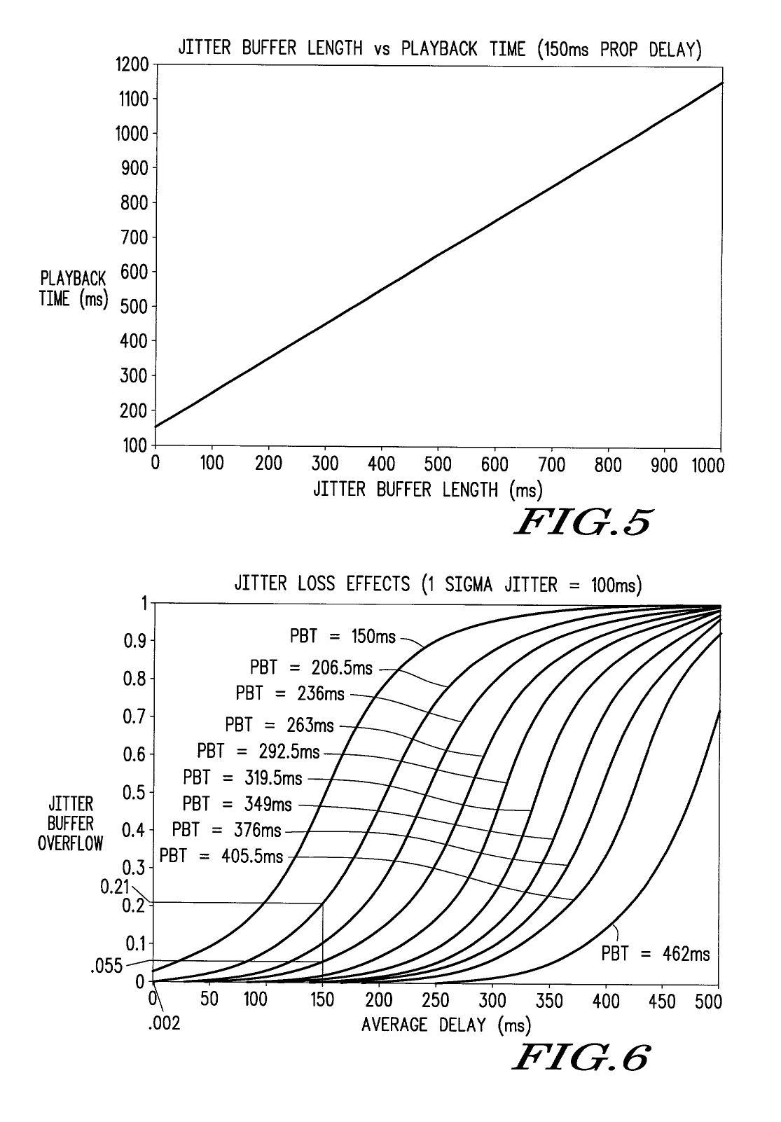

When a packet arrives too late to play out of the jitter buffer, the jitter buffer converts jitter into loss. The pattern of loss depends heavily upon the pattern of the jitter. For ease of illustration and discussion, the graph of FIG. 6 assumes normal distribution of jitter around the average delay. As will be recognized by one of ordinary skill in the art, many tools can be used to make a record of the actual jitter distributions on the network. The graph of FIG. 6 illustrates a network with 1 σ of jitter at 200 ms. For various pbts, the graph plots jitter buffer overflow versus average delay. Different length jitter buffers effectively integrate the normal distribution from negative infinity to a particular time past the average delay. The delay due to the jitter buffer is combined in the graph with all other delays to yield a playback time.

During a burst of speech, the length of the jitter buffer cannot be modified. Such a modification could cause a discontinuity in the output speech in the form of a pause or missing speech, for example. Instead, phase-continuous changes are made to the jitter buffer. In accordance with the preferred embodiment of the present invention, these phase continuous changes are accomplished by adjusting the pbr. A pbr of 0.8 means that 0.8 seconds of encoded speech plays out of the jitter buffer as 1 second of output speech. A pbr of 1 is the most accurate reproduction of the original signal. Empirical analysis has shown that if the pbr is less than 1.0, the jitter buffer grows throughout the burst of speech. If the pbr is greater than 1.0, the jitter buffer shrinks throughout the burst of speech until it reaches a length of 0 ms. The pbr is itself an impairment. FIG. 7 estimates the IF Ie_{pbr} due to pbr. The graph of FIG. 7 can be determined by running MOS experiments as described in Section 2.5 (Opinion Tests) of the Handbook on Telephonometry, ITU-T (CCITT), Geneva 1992.

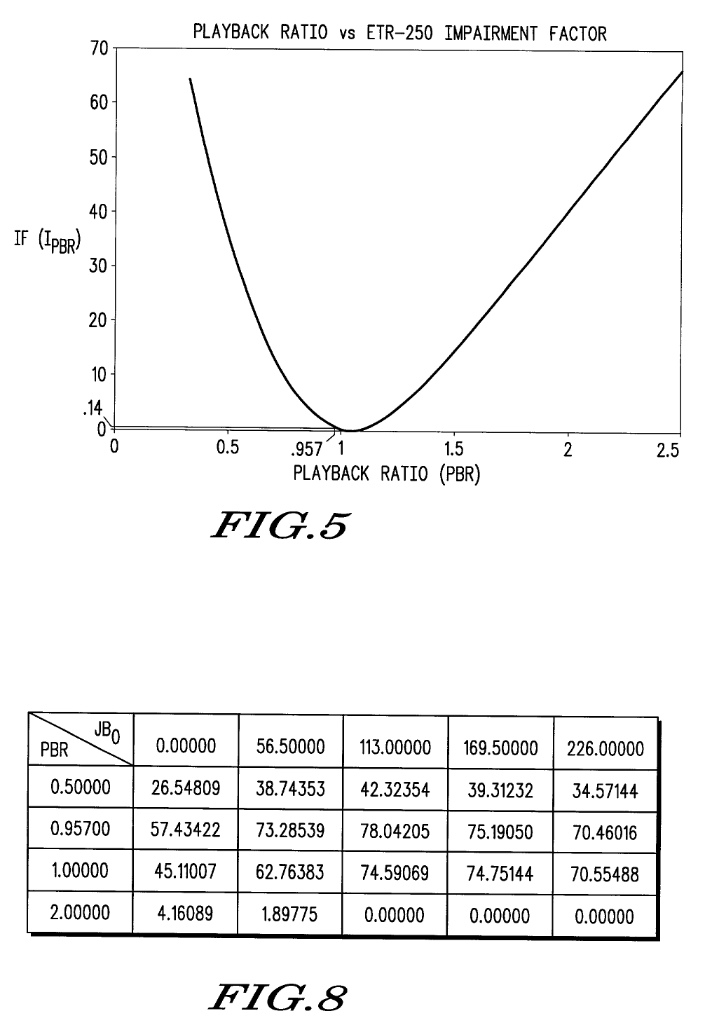

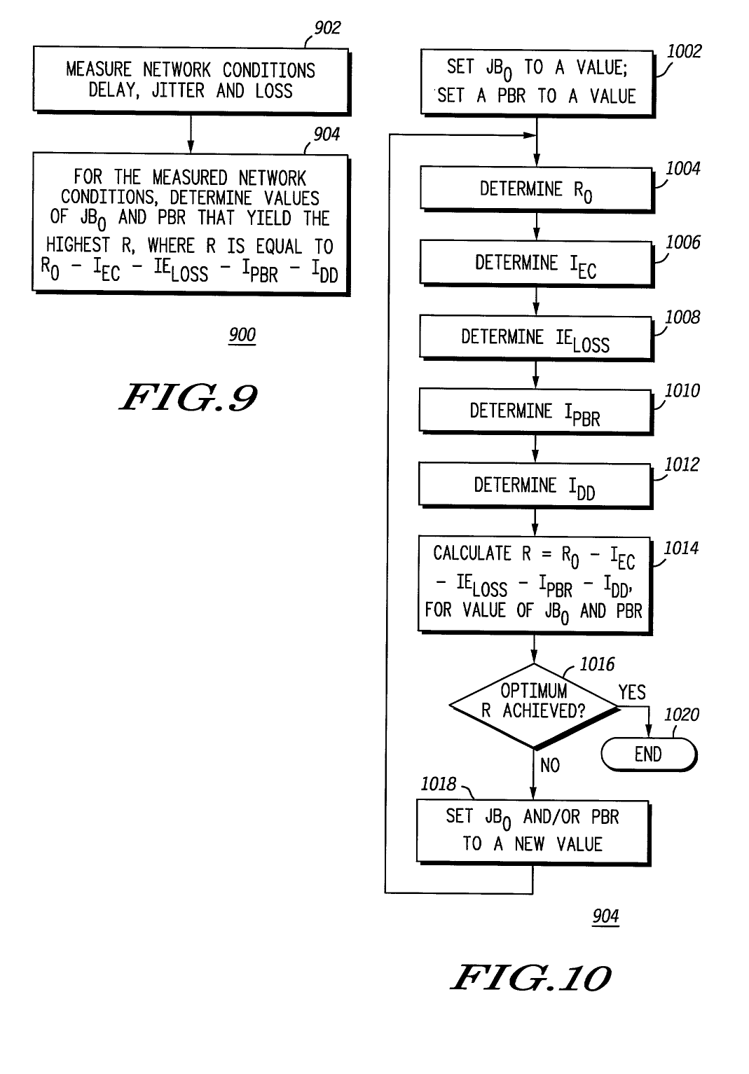

Given a set of network conditions (delay, jitter and loss), the preferred embodiment of the apparatus and method of the present invention undergoes an iterative process to determine the optimum values for the control variables jb₀ and pbr that will yield the best R-factor. The table of FIG. 8 includes the optimum values for jb₀ and pbr (values that yield the highest R-factor) and a few points surrounding the optimum values for measured network conditions: delay=150 ms; jitter=100 ms; and loss=0.04. To illustrate the principles of the invention, two iterations of the process using values of jb₀ and pbr in the table of FIG. 8 will be described with reference to the flow charts of FIGS. 9-11.

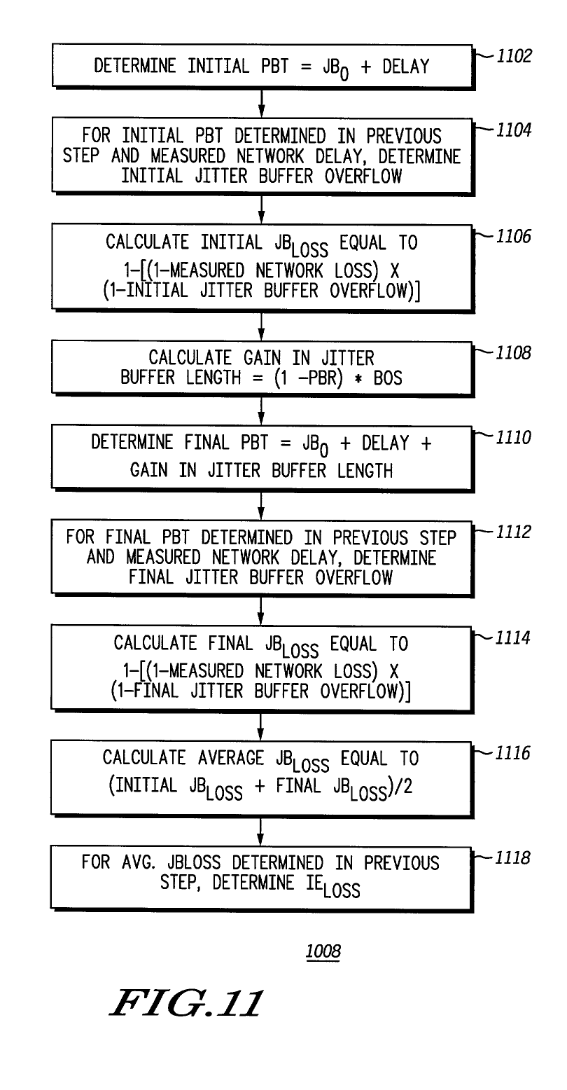

Referring to FIG. 9, the preferred embodiment of the method of the present invention, first measures current network conditions (step 902). In the current example, the measured network conditions are: delay=150 ms, jitter=100 ms and loss=4%. The example also assumes a 2000 ms BOS. Given the values of delay, jitter and loss determined in step 902, the method determines values of jb₀ and pbr that yield the highest R (as defined in equation (1) previously herein) (step 904). In the preferred embodiment of the present invention, R is determined in accordance with the flowchart of FIG. 10. At step 1002, the method begins with an initial value for jb₀ and pbr . For the first iteration in the current example, the initial jb₀ is 56.5 and the initial pbr is 1. (These values, as shown in the table of FIG. 8, are not necessarily the first values chosen by the method, but rather are used for illustrative purposes only.) At step 1004, the method determines R₀. For simplicity of explanation, the current example assumes an ideal system where R₀ is 100. Section 9.1.3.2 of ETR-250, which is herein incorporated by reference, provides an explanation of how to calculate R₀ for a less than ideal system. At step 1006, the method determines Ie_{c}. In the preferred embodiment of the apparatus of the present invention, the voice decoder 104 is a PCM decoder. The impairment factor Ie_{c} for a PCM decoder is 1. At step 1008, the method determines the impairment factor Ieₗₒₛₛ. In the preferred embodiment, Ieₗₒₛₛ is determined according to the flowchart of FIG. 12.

Referring to FIG. 12, the first step in determining Ieₗₒₛₛ is determining an initial pbt (pbt at the beginning of a BOS) according to the equation:

initial pbt=jb₀+delay. (2)

In the current example, the initial pbt is equal to 56.5+150=206.5 ms. For an initial pbt of 206.5 ms and a delay of 150 ms, the method determines the initial jitter buffer overflow (step 1104), preferably using the graph of FIG. 6. As shown in the graph, the initial jitter buffer overflow is 0.21. At step 1106, the method uses the initial jitter buffer overflow to determine an initial jitter buffer loss (jbₗₒₛₛ) according to the equation:

initial jbₗₒₛₛ=1−[(1−loss)×(1−initial jitter buffer overflow)]. (3)

In the current example, the initial jbₗₒₛₛ is 1−[(1−0.04)×(1−0.21)] which equals 0.24. Next, at step 1108, the method calculates the gain in the jitter buffer length during a BOS according to the equation:

gain in jitter buffer length=(1−pbr)×BOS. (4)

In the current example, the gain is (1−1)×2000 which is 0. (This should be the case for a pbr of 1 since 1 second of encoded speech plays out of the jitter buffer as 1 second of output speech.) At step 1110, the method determines the final pbt according to the equation:

final pbt=jb₀+delay+gain in jitter buffer length. (5)

In the current example, the final pbt is equal to 56.5+150+0=206.5 ms. For a final pbt of 206.5 ms and a delay of 150 ms, the method determines the final jitter buffer overflow (step 1112), preferably using the graph of FIG. 6. As shown in the graph, the final jitter buffer overflow is the same as the initial jitter buffer overflow, which is 0.21. At step 1114, the method calculates the final jbₗₒₛₛ according to the equation:

final jbₗₒₛₛ=1−[(1−loss)×(1−final jitter buffer overflow)]. (6)

In the current example, the final jbₗₒₛₛ is 1 −[(1−0.04)×(1−0.21)] which equals 0.24. At step 1116, the method calculates the average jbₗₒₛₛ according to the equation:

average jbₗₒₛₛ=(initial jbₗₒₛₛ+final jbₗₒₛₛ)/2. (7)

In the current example, the average jbₗₒₛₛ is (0.24+0.24)/2 which is 0.24. Using this value of average jbₗₒₛₛ, the method determines impairment factor Ieₗₒₛₛ (step 1118), preferably using the graph of FIG. 4. As shown in the graph, for an average jbₗₒₛₛ of 0.24, Ieₗₒₛₛ is 32.

Referring back to FIG. 10, after determining Ieₗₒₛₛ at step 1008, the method determines impairment factor I_{pbr} (step 1010). Preferably, I_{pbr} is determined from the graph of FIG. 7. As shown, for a pbr of 1, I_{pbr} is 0. At step 1012, the method determines impairment factor I_{dd}. First, the method determines the end-to-end delay according to the equation:

E−E delay=jb₀+delay. (8)

In the current example, the end-to-end delay is 56.5+150=206.5 ms. Using this value of end-to-end delay, the method determines impairment factor I_{dd}, preferably using the graph of FIG. 3. As shown, for an end-to-end delay of 206.5 ms, I_{dd} is 3.72. At step 1014, the method calculates that for jb₀=56.5 and pbr=1, R=R₀−Ie_{c}−Ieₗₒₛₛ−Ie_{pbr}−Ie_{DD}=100−32.5−0−3.72=62.8. This result is shown in the table of FIG. 8 (62.76). At step 1016, the method determines whether the optimum value of R has been achieved. If the answer is yes, the method ends (step 1020) and the values of jb₀ and pbr that yield the highest R has been found. If the answer is no, the method changes the values of jb₀ and/or pbr and repeats steps 1004 through 1014 to calculate a new value of R.

Turning now to the second illustrative iteration of the method, at step 1018 the method sets jb₀ to 113 and pbr to 1. (These values, as shown in the table of FIG. 8, are not necessarily the second values chosen by the method, but rather are used for illustrative purposes only.) At step 1004, the method determines that R₀ is 100. At step 1006, the method again determines that impairment factor Ie_{c} is 1 for a PCM decoder. At step 1008, the method determines the impairment factor Ieₗₒₛₛ, preferably according to the flowchart of FIG. 11.

Referring to FIG. 11, at step 1102 the method determines an initial pbt of 263 (initial pbt=jb₀+delay=113+150). For an initial pbt of 263 ms and a delay of 150 ms, the method determines the initial jitter buffer overflow (step 1104), preferably using the graph of FIG. 6. As shown in the graph, the initial jitter buffer overflow is 0.055. At step 1106, the method uses the initial jitter buffer overflow to determine an initial jbₗₒₛₛ of 0.0928 (initial jbₗₒₛₛ=1−[(1−loss)×(1−initial jitter buffer overflow)]=1−[(1−0.04)×(1−0.055)]). Next, at step 1108, the method calculates a gain in the jitter buffer length of 86 (gain in jitter buffer length=(1−pbr)×BOS=(1−0.957)×2000). At step 1110, the method determines a final pbt of 349 ms (final pbt=jb₀+delay+gain in jitter buffer length=113+150+86). For a final pbt of 349 ms and a delay of 150 ms, the method determines the final jitter buffer overflow (step 1112), preferably using the graph of FIG. 6. As shown in the graph, the final jitter buffer overflow is 0.002. At step 1114, the method calculates a final jbₗₒₛₛ of 0.042 (final jbₗₒₛₛ=1−[(1−loss)×(1−final jitter buffer overflow)]=1−[(1−0.04)×(1−0.002)]). At step 1116, the method calculates an average jbₗₒₛₛ of 0.068 (average jbₗₒₛₛ=(initial jbₗₒₛₛ+final jbₗₒₛₛ)/2=(0.0928+0.042)/2). Using this value of average jbₗₒₛₛ the method determines impairment factor Ieₗₒₛₛ (step 1118), preferably using the graph of FIG. 4. As shown in the graph, for an average jbₗₒₛₛ of 0.068, Ieₗₒₛₛ is 10.3.

Referring back to FIG. 10, after determining Ieₗₒₛₛ at step 1008, the method determines impairment factor I_{pbr} (step 1010). Preferably, I_{pbr} is determined from the graph of FIG. 7. As shown, for a pbr of 0.957, I_{pbr} is 0.14. At step 1012, the method determines impairment factor I_{dd}. First, the method determines and end-to-end delay of 263 (E−E delay=jb₀+delay=113+150). Using this value of end-to-end delay, the method determines impairment factor I_{dd}, preferably using the graph of FIG. 3. As shown, for an end-to-end delay of 263 ms, I_{dd} is 10.5. At step 1014, the method calculates that for jb₀=113 and pbr=0.957, R=R₀−Ie_{c}−Ieₗₒₛₛ−Ie_{pbr}−Ie_{DD}=100−1−10.3−0.14−10.5=78.06. This result is shown in the table of FIG. 8 with slight variation due to rounding errors (78.04).

Between bursts of speech, the preferred embodiment of the invention optimizes call quality by varying the initial jb₀ and the pbr to achieve the best R. During bursts of speech, the value of jb₀ is measured at the time of recalculating R and the pbr is varied to achieve the best R. The method can be during burst of speech and between bursts of speech whenever the network conditions change.

While the invention may be susceptible to various modifications and alternative forms, a specific embodiment has been shown by way of example in the drawings and has been described in detail herein. However, it should be understood that the invention is not intended to be limited to the particular forms disclosed. Rather, the invention is to cover all modification, equivalents and alternatives falling within the spirit and scope of the invention as defined by the following appended claims.

What is claimed is:

1. A method for optimizing customer experience of a real-time system comprising:
collecting statistics from a network;
using the statistics to choose a plurality of parameters;
using the plurality of parameters to manipulate playback properties of the real-time system to optimize the customer experience as measured on a physiological.

2. The method of claim 1 wherein the step of collecting statistics from a network comprises measuring network conditions delay, jitter and loss.

3. The method of claim 2 wherein the step of using the statistics to choose a plurality of parameters comprises for the measured delay, jitter and loss, determining a jitter buffer length and a playback ratio that yield a best R-factor, wherein the R-factor is determined by the equation R=R₀−Ie_{c}−Ie_{pbr}−Ie_{DD}.

4. A method of optimizing jitter buffer length and playback ratio to improve call quality comprising the steps of:
measuring network conditions delay, jitter and loss; and
for the measured delay, jitter and loss, determining a jitter buffer length and a playback ratio that yield a best R-factor, wherein the R-factor is determined by the equation R=R₀−Ie_{c}−Ieₗₒₛₛ−Ie_{pbr}−Ie_{DD}.

5. The method of claim 4 wherein the step of determining a jitter buffer length and a playback ratio that yield the best R-factor comprises the steps of:
a) setting the jitter buffer length and the playback ratio to an initial value;
b) determining R₀;
c) determining Ie_{c};
d) determining Ieₗₒₛₛ;
e) determining Ieₚₕᵣ;
f) determining Ie_{DD};
g) calculating R=R₀−Ie_{c}−Ieₗₒₛₛ−Ie_{pbr}−Ie_{DD};
h) determining whether an optimum value of R has been achieved; and
i) when the optimum value of R has not been achieved, changing the value of jitter buffer length and/or playback ratio and repeating steps b through h.

6. The method of claim 5 wherein the step of determining Ieₗₒₛₛ comprises:
determining an initial playback time;
determining an initial jitter buffer overflow;
using the initial jitter buffer overflow to determine an initial jitter buffer loss;
determining a gain in jitter buffer length;
using the gain in jitter buffer length to determine a final playback time;
determining a final jitter buffer overflow;
using the final jitter buffer overflow to determine a final jitter buffer loss;
determining an average jitter buffer loss from the initial jitter buffer loss and the final jitter buffer loss; and
using the average jitter buffer loss to determine Ieₗₒₛₛ.

7. The method of claim 6 wherein the step of determining an initial playback time comprises solving the equation initial pbt=jb₀+delay.

8. The method of claim 6 wherein the step of using the initial jitter buffer overflow to determine an initial jitter buffer loss comprises solving the equation initial jbₗₒₛₛ=1−[(1−loss)×(1−initial jitter buffer overflow)].

9. The method of claim 6 wherein the step of determining a gain in jitter buffer length comprises solving the equation gain in jitter buffer length=(1−pbr)×BOS.

10. The method of claim 6 wherein the step of using the gain in jitter buffer length to determine a final playback time comprises solving the equation final pbt=jb₀+delay+gain in jitter buffer length.

11. The method of claim 6 wherein the step of using the final jitter buffer overflow to determine a final jitter buffer loss comprises solving the equation final jbₗₒₛₛ=1−[(1−loss)×(1−final jitter buffer overflow)].

12. An apparatus for optimizing customer experience of a real-time system comprising:
a device for collecting statistics from the network;
a control apparatus operatively coupled to the device for manipulating playback properties of the real-time system; and
an optimizer operatively coupled to the device for using the statistics to choose a plurality of parameters for the control apparatus, wherein the plurality of parameters are chosen to optimize the customer experience as measured on a physiological scale.

13. An apparatus for optimizing jitter buffer length to improve call quality comprising:
a jitter buffer;
a voice decoder operatively coupled to the jitter buffer for controlling a rate at which voice date is removed from the jitter buffer;
a voice resampler operatively coupled to the voice decoder for controlling a number of bits removed from the voice decoder; and
a playback optimizer operatively coupled to the jitter buffer and the voice resampler for receiving statistics on a communication link from the jitter buffer, for using the statistics to determine a jitter buffer length and playback ratio that yield an optimum score on a physiological scale and for sending the jitter buffer length and playback ratio to the voice resampler to improve call quality.
